(19) United States
(12) Patent Application Publication
(10) Pub. No.: US 2014/0278994 A1
(43) Pub. Date: Sep. 18, 2014

(54) Interactive Mobile Engagement Recharging Terminal System and Device

(71) Applicants: Richard J. Greenwood, Chicago, IL (US); Kevin Ross, Cortland, OH (US); William Krasner, Maple Park, IL (US)

(72) Inventors: Richard J. Greenwood, Chicago, IL (US); Kevin Ross, Cortland, OH (US); William Krasner, Maple Park, IL (US)

(21) Appl. No.: 14/213,728

(22) Filed: Mar. 14, 2014

Related U.S. Application Data
(60) Provisional application No. 61/784,212, filed on Mar. 14, 2013.

(51) Int. Cl. H04B 1/38; G06Q 30/02

(52) U.S. Cl. CPC H04B 1/3883; G06Q 30/0257
USPC 705/14.55; 455/556.1

(57) ABSTRACT

The present invention is a digital interactive mobile engagement recharging device for users to plug in personal mobile devices. The recharging device has an interactive touch display screen that connects to a computer and to the Internet to provide remote and real-time content push of interest to a user, and a plurality of recharging connections to accommodate various models and brands of mobile devices. The recharging system collects information about a user's mobile device and provides recharging services to the user's mobile device after the user accepts certain terms or conditions, outputs information such as the recharging status of a user's phone, commercial information selected by a computer based media system, where the selected information is based on the information collected by the input devices of the system and provides pre-selected or user demanded information. It is yet another object of the present invention to provide commercial data to a user based on the interactive information, such as the detected users' characteristics, location or temperature of the venue, and the like.

This application claims priority from application Ser. No. 61/784,212 filed Mar. 14, 2013 which is hereby incorporated herein in its entirety by reference.

### BACKGROUND OF THE INVENTION

The present invention is in the technical field of mobile electronic device recharging terminals. More particularly, the present invention is in the technical field of digital interactive mobile engagement recharging devices and the method of using such devices.

Conventional mobile charging devices, such as standard charging stations, battery packs, charging towers and the like, are typically costly, limited in power capacity and quality, or non-engaging with the user. It is difficult to rely on these devices for a convenient power source because they are not conveniently accessible, are limited in power storage functions, and lack the ability to provide touch interactive digital information. Finding such devices is typically daunting as they are not readily available in public venues where people expect them, and namely need them. Using such devices is usually mundane and boring even if the service is free because the user must wait for prolonged periods while awaiting a recharge, and has no access to any immediate entertainment or relevant information besides sponsored advertisements. The user generally disengages from the unit after a short period with limited charging as a result.

Similar charging kiosks with individual device locker units pose user issues when the locker unit malfunctions and leaves the user deviceless with no attendant in close proximity to offer support. The user will have difficulties retrieving the device if the user forgets or misplaces the temporary lock code or bar coded receipt or other technical failure in the case of kiosks with a credit card acceptor that requires a user to swipe their card in order to unlock the device locker units. When combined with digital signage, the difficulties of introducing such a device into a venue are multiplied because of the charging kiosks' bulky size and massive frame. It makes positioning such a device challenging because space and location options become limited. Further, in order to use the device the mobile device users must pay a given fee through an electronic terminal attachment. Charging kiosks that accept payment for their charging feature do not function properly because of the incompatibility between the payment terminal and the charging mainboard. The mobile user typically ends up with multiple invalid transactions on their bank statement.

The venue owner may also have to pay through a lease to obtain a charging kiosk installed at a given cost and take on the risk of the investment without any guaranteed benefit of a return on investment. Further, the devices do not provide the venue owner with the flexibility of choosing how to integrate the kiosk to match the aesthetics and layout of its setup location.

### SUMMARY OF THE INVENTION

The present invention is a digital interactive mobile engagement recharging device for users to plug in personal mobile devices. The recharging device has an interactive touch display screen that connects to a computer and to the Internet to provide remote and real-time content push of interest to a user, and a plurality of recharging connections to accommodate various models and brands of mobile devices.

It is one object of the present invention to provide a system that collects information about a user's mobile device and provides recharging services to the user's mobile device after the user accepts certain terms or conditions.

It is one object of the present invention to provide an interactive system that outputs information such as the recharging status of a user's phone, commercial information selected by a computer based media system, where the selected information is based on the information collected by the input devices of the system.

It is yet another object of the present invention to provide pre-selected or user demanded information. The system also delivers the information wirelessly.

It is yet another object of the present invention to provide commercial data to a user based on the interactive information, such as the detected users' characteristics, location or temperature of the venue, and the like.

### BRIEF DESCRIPTION OF THE DRAWING

FIG. 1 is a front view of a digital interactive mobile engagement recharging device of the present invention;

FIG. 2 is a detailed front perspective view of the digital interactive mobile engagement recharging device of FIG. 1;

FIG. 3 is a side view from one side of the digital interactive mobile engagement recharging device of FIG. 1;

FIG. 4 is a side view from another side of the digital interactive mobile engagement recharging device of FIG. 1;

FIG. 5 is a rear view of the digital interactive mobile engagement recharging device of FIG. 1;

FIG. 6 illustrates the recharging system components and the connections between the components;

FIG. 7 is a flow diagram showing the program flow of how the present system interacts with one user; and

FIG. 8 is an illustration of the functions of the core application software.

### DETAILED DESCRIPTION OF THE INVENTION

FIG. 1 and FIG. 2 show a terminal 10 having a camera 14 for capturing real-time images mounted above an HD LCD multi-touch screen 12. The HD LCD multi-touch screen 12 is held in a substantially level position elevated above a recharging bay area 16 by two enclosure panels, namely a front panel 18 and a rear panel 20. Panels 18 and 20 are attached to each other to create a full protection enclosure for the HD LCD multi-touch screen 12 and the camera 14.

The HD LCD multi-touch screen 12 is sufficiently wide and long for comfortable viewing, such as about twenty-seven inches tall to about fifteen inches wide. The enclosure panels 18 and 20 are sufficiently tall to hold the HD LCD multi-touch screen 12 in a secure position, such as about forty-four inches tall and twenty-one inches wide.

The HD LCD multi-touch screen 12 has touch capability allowing the terminal to be interactive to the user while the user is waiting during recharging a mobile device at the terminal. The HD LCD multi-touch screen 12 is connected to an integrated computer based media system that provides the content displayed on the HD LCD multi-touch screen 12. The HD LCD multi-touch screen 12 can be placed in horizontal or vertical directions, in order to accommodate the needs of the displaying venue. In portrait orientation the screen 12 can only function in a single interface experience display where end users share the same user interface. In landscape orientation the user interface can be split into two separate experiences that allow for a multi-player user experience. The integrated computer based media system can be either local, or remotely connected to the HD LCD multi-touch screen 12 through broadband connections. The interactions provided by the HD LCD multi-touch screen 12 include games, business information, commercial advertisements, and push notifications of the recharging status of the charged mobile device. The process to provide such services and content of the information provided will be detailed in this document.

The camera 14 can take pictures of the user while the user is using the recharging terminal 10. The camera 14 provides live stream with other cameras that the user wishes to connect with to provide face to face interactions. The face to face interaction will be displayed on the HD LCD multi-touch screen 12 to assist the user in conducting video conferences or taking, pictures of themselves.

The camera 14 uses facial recognition software to register user impression metrics. The facial recognition software obtains the image of the user in front of the terminal HD LCD multi-touch screen 12, and analyzes relevant information such as the user's age, gender, and the user's viewing time and duration. The information analyzed by the facial recognition software is used to provide a studying basis for the optimization of content distribution on the terminal 10.

The recharging bay area 16 is adequately dimensioned to house the recharging plugs 22 and the device tray 24. In one embodiment, the recharging bay area 16 is about eleven inches wide by about two inches tall and about two inches deep. The device tray 24 is outwardly extendable so it can be opened and closed for holding the mobile device or devices while they are being charged. The device tray 24 is sufficiently adequate for holding one or more mobile devices, such as being about eleven inches wide by about four inches deep. The recharging plugs 22 are long enough to be extended to mobile devices, such as being about eight inches long. Different recharging plugs 22 with varying connection profiles are provided in order to meet the needs of the user to charge different user devices.

In one other embodiment, there can be a plurality open slots parallel to each other, either vertically or horizontally to match the orientation of the HD LCD multi-touch screen 12. The slots are designed in four manufactured enclosure blocks with three slots per block.

Referring to FIG. 3 and FIG. 4, the figures show the sides of a front enclosure panel 18 and a rear enclosure panel 20 for the terminal 10. On one side of the device, the panels 19 and 20 are secured together by two locking mechanisms, namely a top lock 26 and a bottom lock 28. An adjoining hinge 62 such as about thirty-eight inches long secures the other side of the enclosure panels 18 and 20. The locks 26 and 28 can be opened and front enclosure panel 18 can be rotated with regard to the hinge 62 to open the enclosure formed by the panels 18 and 20 in the illustrated embodiment. A sufficiently compact rear mount enclosure 30 is attached to the rear panel 20 to house and protect the rear components of the HD LCD multi-touch screen and the integrated computer based media box inside the terminal 10. The rear mount enclosure 30 is small enough to ensure the terminal does not become bulky and extend too far off a wall or standing mount. Enclosure 30 encloses the back of the HD LCD multi-touch screen 12 and the integrated computer based media box inside the terminal 10. The rear mount enclosure 30 in the illustrated embodiment is about twenty-four inches tall, about fourteen inches wide and about two inches deep. The rear mount enclosure 30 is provided with air flow cooling support through five side positioned air vents, namely a top-right side vent 32, a middle-right side vent 34, a bottom-right side vent 36, a bottom-left side vent 58, and a top-left side vent 60. Also attached to rear panel 20 is a small power distributor 48 to regulate power to the terminal.

FIG. 5 shows a media box guard 52, as well as a wireless antenna 50 in the range of six inches in length appropriately positioned and placed for connectivity of the terminal 10. The wireless antenna 50 provides remote wireless connections between the device and a remote broadband network. There is also shown a screen input guard 46 attached by four support mounts, namely a first mount 38, a second mount 40, a third mount 42, and a fourth mount 44 shown in FIG. 3 that hold the guard 46 tightly in place in order to protect and provide access to the HD LCD multi-touch screen inputs. Both guards 46 and 52 are compact in size for guarding component parts, such as about seven inches tall by about three inches wide and about two inches deep in the illustrated embodiment.

FIG. 5 also shows three fan units, namely a left fan 54, a middle fan 64, and a right fan 56 which are externally attached to the rear mount enclosure 30 for added cooling and air flow support. The rear mount enclosure 30 is also provided with air flow cooling support through a single rear positioned air vent, namely a bottom-left rear vent 66, in addition to side positioned air vents 32, 34, 36, 58, and 60. Cooling and ventilation for the HD LCD multi-touch screen 12 and other recharging components are provided through the rear panel 20 by five rear positioned air vents, namely a top-left rear vent 68, a top-middle rear vent 70, a top-right side vent 72, a middle-right side vent 74, and a bottom-right side vent 76 in order to prevent overheating and subsequent malfunction.

The construction details of the invention as shown in FIG. 1, FIG. 2, FIG. 3, FIG. 4, and FIG. 5 are that the terminal 10 may be made of metal or of any other sufficiently rigid and strong material such as high-strengthen plastic, carbon fiber, composite materials, and the like. Further, the various components of the terminal 10 can be made of different materials.

In one embodiment of the present invention, when a user comes to the terminal and begins recharging a mobile device, the mobile device is optionally placed on the device tray 24, and the device tray 24 is outwardly extended to support the user's device while the device is recharging. The recharging system components are illustrated in FIG. 6. The recharge module 603 connects the user's mobile devices 601 through USB interfaces with the main local computer system 605. One USB interface communicates with the core Android system and the other USB interface acts as a USB hub for the connected mobile device. The communication with the core-Android system is accomplished via Android Open Accessory (AOA) standard. The AOA standard is also used to update the recharge module's firmware in addition to requesting the information of the connected device(s) and the amount of charge left for a device. The charge left for the device can be displayed on the HD LCD screen 12 in either time or percentage or both formats. The present recharge module is capable of recharging various different mobile devices with different mobile operating systems, but is not limited to recharging Android devices.

When the mobile device 601 is connected to the main local computer system 605, the user has to trigger the recharge module 603's recharging ability by accepting the liability disclaimer appearing on the multi-touch screen 12. Without agreeing to the liability disclaimer, the recharging process will not be activated and the user's mobile device will not be recharged. The liability disclaimer is prompted via the main local computer system 605. In one embodiment the liability disclaimer is displayed in a pop-up window at the bottom of the multi-touch screen 12. When the recharging is activated, the main local computer system 605 captures the information about the connected mobile device 601 and displays the information on the HD LCD screen 12. An example of the captured information includes: the mobile device ID using the International Mobile Station Equipment Identity (IMEI), and the total charge duration of each connected mobile device. The information the main local computer system 605 collected about the user's mobile device(s) 601 helps a user to stay informed on the recharging status of the user's connected device. The collected information is also transmitted back to the remote controlling system 607 and later used in the usage analytics to support advertiser related metrics, which will be further explained in the present document.

The recharge module 603 can connect to and charge several mobile devices simultaneously. In one embodiment, the recharge module 603 can charge up to twelve devices 601. A liability disclaimer described above will show up each time one additional mobile device 601 is connected to the recharge module 603. The second and following liability disclaimers are displayed in a pop-up window that does not completely disrupt the first user's experience, such as at the bottom or corner of the HD LCD screen 12. When the recharging for each device 601 is activated, the recharging devices 601 are identified on the screen 12 by the corresponding numbered recharging port they are connected to. The captured information is also displayed for each of the connected devices 601 on the main screen 12 when the devices 601 are connected to the main local computer system 605. The HD LCD multi-touch screen 12 facilitates the user to accept the second and following liability disclaimer while the first user is still actively using the touch screen 12. The HD LCD screen 12 will provide the user the numerical battery display status to show recharging progress. The user then optionally retracts the device tray 24 if used after retrieving their mobile device when they determine the recharging process is sufficiently complete. With the numerical battery status display, the users do not need to repeatedly view their mobile device to check the recharge status.

When the user triggers the recharging process, the main local computer system 605 also activates the sterilization module 609. The system uses known Ultraviolet Germicidal Irradiation (UVGI) technology to complete the sterilization process directed to the mobile devices 601. Low-pressure mercury (Hg) discharge lamps are commonly used in UVGI applications and emit shortwave ultraviolet-C (UV-C, one hundred to two hundred and eighty nanometer [nm]) radiation, primarily at two hundred and fifty four nm. In one embodiment, at least one small ultraviolet-C (UV-C) lamp is placed inside each mobile device slot to enable surface decontamination of inserted mobile devices. UV-C radiation kills or inactivates microbes by damaging their deoxyribonucleic acid (DNA). This feature interacts with the recharge module 603 and is activated by the main local computer system 605 in the terminal 10. Whenever a user initiates a mobile recharge through the application interface, the same action will also trigger the initiation of the corresponding ultraviolet-C (UV-C) lamp inside the respective mobile device slot. When the user disengages the recharging functionality, then the ultraviolet-C (UV-C) lamp will also disengage and stop sterilization.

Referring now to FIG. 7, the work flow of the main computer system is illustrated in the diagram. Before the mobile device is connected to the recharge module, the screen 12 displays the idle screen interface at step 701. The user initiates the interaction with the main system by either touching the screen 12 while the screen 12 is displaying idle interface, or by plugging one mobile device into one recharging port at the recharge module, at step 703. When the user touches the screen 12 at idle interface, the screen displays either the advertising page at 705, or the welcome page at step 707 if there is no advertising page ready for the user at step 705. If the user selects the displayed advertising page at step 705, the main local system takes the user to the user application interface of the selected application at step 725. The welcome page 707 is also displayed to users that plug the mobile device into the charger at step 703. The main local system determines whether the phone is attached at step 709. If the main local system determines there is no phone attached, the screen 12 will display a window with recharging instructions at step 711, and asks if the user desires to skip the recharging instructions at step 715. If the user opts to skip the instructions and continue using the terminal 10 without plugging in a mobile device, the user will be directed to a launcher instructions window at step 721. If the mobile device is determined to be plugged in at step 609, the main local system then displays the user agreement on the screen 12 at step 713 for the user's acceptance at step 717. Only when the user accepts the displayed agreement at step 717 will recharging be activated at step 719. Without agreeing to the user agreement at step 717, the main local system will not activate the charge for the user's mobile device. However, a user may still use the displayed services provided by the terminal without recharging the mobile device. Therefore, if the user chooses not to accept the agreement at step 717, the main local system directs the user to the launcher instructions at step 721. Once a mobile device charge is activated, the user is also directed to the launcher instructions at step 721. The launcher is then displayed at step 723. The launcher directs users to the selected, application interface at step 725.

The launcher 811 is supported by a remote core application software 807 used to deliver a smartphone experience on the HD LCD screen 12 as shown in FIG. 8. Each installed application 809 package file (APK) is connected to the core application software. The core application software 807 enables location based marketing or digital place-based advertising that is relatively contextual to the end-user searching criteria.

The core application software 807 supports an ad engine 805 and an offers engine 803 in order to push creative content and offers to specific layout positions on the screen 12. The layout positions are defined as ad inventory and scheduling slots and are specified as beacons below:

Beacon 1—Idle Screen Attract Loop

Beacon 2—Idle Screen Coupon Offer

Beacon 3—Idle Screen Coupon Offer

Beacon 4—UI Base Screen Ad Banner

Beacon 5—Launcher Attract Loop

Beacon 6—In-App Coupon Offer Banner

Beacon 7—In-App Coupon Offer Pop-Up

Beacon 8—Launcher Sponsored Logo

Beacon 9—Photo-booth Loader

Beacon 10—Photo-booth Frame

The ad engine 805 and the offers engine 803 are separately accessible and manageable remotely at 801 through the Internet. The ads and offers managed remotely to be published can be scheduled against specific variables such as day of the week, time of the day, temperature, special calendar holidays, and the like. Remote management 801 is provided via independent web logins that provide network visibility and creative content format flexibility that meet the system's requirements. These variables are further defined as:

Media type—Static, Motion Graphic, Video

Media duration—10 seconds, 15 seconds, 30 seconds

Airtime duration—1 months, 6 months, 12 months

Network coverage—Total number of units display on

Network location—Exact physical location of a unit

The camera 14 obtains an image of the user in front of the HD LCD screen 12 and sends the image data to the core application software 807 through the main local computer system 605. The core application software 807 then triggers the ad engine 805 and offers engine 803, which use the demographic analytics captured through facial recognition to push creative content based on end-user variables.

The core application software 807 also transmits data visible on the screen 12 to the user's mobile device 601 using Quick Response (QR) Code, Short Message Service (SMS), Electronic Mail (Email), Near Field Communication (NFC), and BLUETOOTH Low Energy connection. The core application software 807 registers and logs each engagement for either application or ad content download. The recorded download statistics are used for later studies and optimization for content distribution through the recharging terminal 10.

Information obtained by the main local computer system 605 and the core application software 807 can be used in different ways to provide optimization for the content push. These different analytics include:

Mobile analytics—Reported by the recharge module 603 to the main local computer system 605 and is aggregated by the unique device ID and the device recharge duration.

Engagement analytics—Reported by the core application software 807 to the main local computer system 605 and is aggregated by unique touch interactions that generate downloadable links or social media platform posts.

Demographic analytics—Reported by the digital camera 14 using a facial recognition software 815 to register audience impression metrics and is aggregated by a real-time count of viewers by variables such as gender and age range and their viewing times and durations.

The core application software 807 also promotes developer applications and facilitates end-user application trials via mobile engagement delivery through an application discovery module 813. Mobile phone applications 809 are presented in a featured list or a general list and are also categorized by related genres. Application 809 downloads are also recorded for analysis. The users are not paying for use of the terminal 10, therefore the requested information collected will be anonymous. The users will also be provided with a sense of comfort against charge frauds, erroneous bank transactions, or issues of unauthorized disclosures of personal information and privacy.

The core application software 807 supports social media interaction through specific applications 809 such as News, and Photo-booth to post and share content displayed to the end-user on various social platforms such as FACEBOOK, TWITTER, and INSTAGRAM.

The core application software 807 functions in both portrait and landscape screen layout depending on the orientation of the digital signage display 12. The display format's aspect ratio is modified to accommodate the required user interface layout.

When the user exits the application, the main local system returns the program to the launcher interface at step 723, so the user may restart the selecting process and be directed to the application interface at step 725.

The recharging is stopped when the device is fully charged, or the user chooses to disconnect the device 601 from the terminal 10 at any time after the charge is triggered. When the device 601 is fully charged or the user disconnects the mobile device from the terminal 10, the main local computer system 605 will automatically stop the flow of electricity from the terminal 10 to the mobile device 601 through the recharging port. When the user chooses to exit the entire program, the screen 12 returns to idle interface at step 727.

The main local computer system 605 is embedded in the computer module at the terminal 10 that connects to the remote core application software 807 through the Internet. The remote core application software 807 provides the greatest benefit to the advertiser as they will be able to manage creative content independently and real-time. For example, photos and videos are wrapped via use of the camera with advertiser banners. The main local computer system 605 on the terminal 10's inside receives the demand and request from the user through the HD LCD multi-touch screen 12. The user selects the service provided or types in the requested information. The remote core application software 807 will respond to the user's request with real-time information pushed and displayed on the HD LCD multi-touch screen 12. The real-time information has several advantages over pre-embedded information. Real-time information is responsive to the user's requests and is more accurate. Because there is no delay in the timeliness of the information provided, the real-time data can provide services such as navigation or tracking.

Provided that the user can use the HD LCD multi-touch screen 12 to interact with the main local computer system 605 at the terminal 10 and obtain the information requested or obtain access to immediate entertainment, the user stays near the terminal 10 during the recharging process.

The above described terminal device is relatively small in depth and lightweight. The terminal 10 can sit on a stand or be mounted on a wall. Moving such devices typically requires at most two persons when taking the device from one location to another. Further, the devices generally will provide a quick recharge to any mobile device without any associated cost while allowing the user to be entertained through the touch interactive digital signage screen 12. Installing the recharging terminal in a venue does not always require the venue owner to pay for the equipment or installation as they are provided with multiple options to acquire a terminal. The end user of the recharging terminal will not pay for the use either. Because the user is interacting with the HD LCD multi-touch screen 12 while the mobile device is being recharged, the advertisement and information displayed on the HD LCD multi-touch screen 12 can generate the revenue to cover the installation and use of the device, and also bring in further profits. Displayed information includes digital games, interactive advertisements, social media integration, and movie trailers.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. An apparatus for providing interactive information and for charging at least one electronic mobile device, comprising:
at least one digital screen display device;
at least one digital camera capturing images upon request from a user, said digital camera electronically connected to said digital screen display device;
at least one charging area, said charging area accessibly enclosing at least one mobile device charger;
a local processing unit processing data received from said digital screen display device and said at least one electronic mobile device when said at least one electronic mobile device is being charged by said at least one mobile device charger; and
at least one remote data processor electronically connected to said local processing unit, said remote data processor adapted to receive data from said local processing unit and deliver selected data from a remote data center to said local processing center.

2. The apparatus of claim 1, wherein
said apparatus includes a sterilization module, said sterilization module active to sterilize the at least one mobile device only when the at least one mobile device is actively charging.

3. A method for electronically interacting with a user when the user is charging a mobile device, comprising:
electrically connecting a mobile device to a charger in a recharging terminal to initiate a charging process;
obtaining the user's acceptance to a liability agreement to activate the charging process;
electronically obtaining information from said mobile device and displaying at least part of the information obtained on a digital screen, said digital screen located in proximity to said recharging terminal;
obtaining at least one request for information from said user;
retrieving the requested information from a remote data source, and transmitting said requested information to a local operating system for said recharging terminal;
displaying the retrieved information on said digital screen; and
terminating the charging process.

4. The method of claim 3, wherein
said method includes obtaining said user's image through a camera.

5. The method of claim 4, wherein:
said method includes analyzing a user's data preference through a facial recognition program.

6. The method of claim 5, wherein:
said method includes combining said at least one request for information from said user with said user's data preference before retrieving the requested information from the remote data source.

7. The method of claim 5, wherein:
said facial recognition program analyzes said user's information comprising age and gender to predict said user's data preference.

8. The method of claim 3, wherein:
said remote data source obtains information from an offers engine.

9. The method of claim 3, wherein:
said remote data source obtains information from an advertising engine.

10. The method of claim 3, wherein:
said remote data source obtains information from an application discovery module.

11. The method of claim 3, wherein:
said retrieved information from a remote data source comprises entertainment selected from digital games, interactive advertisements, social media integration, and movie trailers.

12. The method of claim 3, wherein:
said retrieved information from a remote data source is scheduled against at least one variable comprising day of the week, time of the day, temperature, special calendar holidays, media type, media duration, network coverage, and network location.

13. The method of claim 3, wherein:
said information obtained from said mobile device comprises a mobile device ID, a total charge duration of said mobile device, and an amount of charge remaining for said mobile device.

14. The method of claim 3, wherein:
said method comprises sterilizing said mobile device while said charging process is activated.

15. The method of claim 3, wherein:
said charging process is terminated when at least one of the mobile device is fully charged, and when said charging process is sufficiently completed to the user's satisfaction.

16. The method of claim 3, wherein:
said remote data center provides optimization for the retrieved information from a remote data source through at least one analytics, said analytics comprising mobile analytics, engagement analytics, and demographic analytics.

17. The method of claim 3, wherein:
said transmitted information displayed on said digital screen transmits to said user's mobile device wirelessly, through methods comprising at least one of Quick Response Code, Short Message Services, Electronic Mail, Near Field Communication and a personal wireless network.

18. The method of claim 4, wherein:
said information displayed on said digital screen and obtained by said camera is transmitted to at least one social platform.

19. The method of claim 3, wherein:
said retrieved information from a remote data source is displayed on the screen as at least one beacon comprising at least one of an idle screen attract loop, an idle screen coupon offer, an UI base screen ad banner, a launcher attract loop, an in-app coupon offer banner, an in-app coupon offer Pop-up, a launcher sponsored logo, a photo-booth loader, and a photo-booth frame.
